(19) United States
(12) Patent Application Publication
(10) Pub. No.: US 2026/0251774 A1
(43) Pub. Date: Aug. 27, 2026

(54) METHODS, APPARATUS, AND SYSTEM FOR SENSING USING MEASUREMENT FUSION

(71) Applicant: Huawei Technologies Co., Ltd., Shenzhen (CN)

(72) Inventors: Ahmed Wagdy Abdelwahab Shaban, Kanata (CA); Alireza Bayesteh, Brossard (CA); Jianglei Ma, Ottawa (CA)

(21) Appl. No.: 19/465,576

(22) Filed: Jan. 30, 2026

Related U.S. Application Data
(63) Continuation of application No. PCT/CN2023/132842, filed on Nov. 21, 2023.
(60) Provisional application No. 63/517,422, filed on Aug. 3, 2023.

(51) Int. Cl. G01S 13/58; G01S 7/00

(52) U.S. Cl. CPC G01S 13/584; G01S 7/006

(57) ABSTRACT

Aspects of the present application relate to configuring a target UE to be a sensing reception node. That is, the target UE may be provided with a configuration that allows the target UE to collect sensing information, where generation of the configuration takes into consideration low power and low computational complexity. The configuration may be based on receiving a chirp-based sensing waveform, a plurality of measurements over a plurality of frequency bands or, equivalently, over a plurality of time slots, due to time-frequency relation of chirp-based signals. This may enable fusing these measurements in the frequency domain and/or the time domain, thereby producing fused measurements.

### CROSS-REFERENCE TO RELATED APPLICATIONS

The present application is a continuation of International Patent Application No. PCT/CN2023/132842, filed on Nov. 21, 2023, which claims the benefit of U.S. Patent Application No. 63/517,422, and filed on Aug. 3, 2023. The entire contents of the aforementioned applications are hereby incorporated by reference.

### TECHNICAL FIELD

The present disclosure relates, generally, to wireless communication and, in particular embodiments, to sensing of communication devices and, even more particularly, to sensing using measurement fusion.

### BACKGROUND

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information. UE pose information may be understood to include a UE location in a global coordinate system, a UE velocity and direction of movement in the global coordinate system and UE orientation information. The sensing system may also be used to help gather information about the wireless environment. “UE location” is also known as “UE position” and these two terms may be used interchangeably herein. Examples of well-known sensing systems include Radio Detection and Ranging (RADAR) and Light Detection and Ranging (LIDAR). While the sensing system can be separate from the communication system, it may also be shown to be advantageous to gather the sensing information using an integrated system. An integrated system may be shown to gather sensing information based on communication signals. Integrated systems may be shown to reduce a quantity of hardware, and commensurate cost, relative to systems that achieve both functionalities using separate hardware. Integrated systems may also be shown to reduce time, frequency or spatial resources employed

However, using an integrated system, wherein communication system hardware perform sensing of UE pose and environment information, may be shown to be a highly challenging and open problem. The difficulty of the problem relates to a plurality of factors, such as limited resolution of the communication system hardware, dynamicity inherent in the environment and a relatively large number of objects whose electromagnetic properties and position are to be sensed.

Accordingly, integrated sensing and communication (also known as integrated communication and sensing, joint sensing and communication and other, similar, names) is a desirable feature in communication systems.

### SUMMARY

Aspects of the present application relate to configuring a target UE to be a sensing reception node. That is, providing the target UE with a configuration that allows the target UE to collect sensing information, where generation of the configuration takes into consideration low power and low computational complexity. The configuration may be based on receiving a chirp-based sensing waveform, a plurality of measurements over a plurality of frequency bands or, equivalently, over a plurality of time slots, due to time-frequency relation of chirp-based signals. This may enable fusing these measurements in the frequency domain and/or the time domain, thereby producing fused measurements. The fused measurements may be shown to increase an aggregated bandwidth and, thereby, the fused measurements may be shown to increase sensing resolution. Through appropriate configuration of the chirp-based sensing signal, the parameters reported by a sensing reception node, to a sensing transmission node, may allow the sensing transmission node to obtain a range and/or a Doppler frequency for the sensing reception node. Notably, the measurement fusion process may be carried out at the sensing reception node or at the sensing transmission node.

As discussed hereinbefore, the use of an integrated system, wherein communication system hardware perform sensing of UE pose and environment information, may be shown to be a highly challenging and open problem. The difficulty of the problem relates to a plurality of factors, such as limited resolution of the communication system hardware, dynamicity inherent in the environment and a relatively large number of objects whose electromagnetic properties and position are to be sensed.

Furthermore, it may be considered that there is likely to exist a bottleneck in obtaining relatively high-resolution sensing information in next generation wireless communication systems, wherein only a relatively small amount of the communication system hardware is capable of communicating while sensing UE pose and environment information.

Conveniently, those aspects of the present application that relate to sensing procedures may be shown to be associated with power consumption and computational complexity that is reduced relative to power consumption and computational complexity associated with known sensing procedures.

One advantage of sensing procedures representative of aspects of the present application is the provision of relatively high-resolution sensing information related to a sensing reception node. Some aspects of the present application utilize a node-specific chirp-based sensing signal. Some aspects of the present application that are related to node-specific chirp-based signals facilitate the proper fusion and interpolation of the sensing measurements to, thereby, gain high-resolution sensing information.

According to an aspect of the present disclosure, there is provided a method of sensing. The method includes communicating configuration information for linear frequency modulated signals. The configuration information includes, for a given linear frequency modulated signal among a plurality of linear frequency modulated signals, at least one of an indication of a frequency band or an indication of a measurement time window. The method further includes transmitting the plurality of linear frequency modulated signals to a sensing receiver node.

In some embodiments, communicating the configuration information comprises transmitting the configuration information to the sensing receiver node. In some embodiments, communicating the configuration information comprises receiving the configuration information from a network node.

In some embodiments, the method further includes receiving feedback from the sensing RX node. The feedback includes a value for a sensing parameter estimated at the sensing receiver node, based on a fusion of measurements, made at the sensing receiver node, of the plurality of linear frequency modulated signals. The method further includes receiving, from the sensing receiver node, an indication that the fusion of measurements has been successful. In some embodiments, the method further includes processing the sensing parameter to obtain a range.

An apparatus is also provided to carry out this method. A computer-readable medium is provided storing instructions to cause a computer to carry out this method. A computer program is provided to cause a computer to carry out this method.

According to an aspect of the present disclosure, there is provided a method of facilitating obtaining of a position for a sensing RX node. The method includes receiving, at the sensing RX node from a sensing TX node, configuration information for a plurality of chirp-based sensing signals, the configuration information including, for each chirp-based sensing signal among the plurality of chirp-based sensing signals, an indication of a frequency band and an indication of a measurement time window, receiving, at the sensing RX node from the sensing TX node, over the bandwidth parts and the measurement time windows, the plurality of chirp-based sensing signals and transmitting, from the sensing RX node to the sensing TX node, feedback, the feedback including a sensing parameter estimated at the sensing RX node, based on a fusion of measurements, made at the sensing RX node, of the plurality of chirp-based sensing signals. An apparatus is also provided to carry out this method and a computer-readable medium is provided storing instructions to cause a processor to carry out this method.

According to an aspect of the present disclosure, there is provided a method of grouping measurements of sensing signals. The method includes receiving, over a plurality of frequency bands and a plurality of measurement time windows, a plurality of linear frequency modulated signals. The method includes obtaining an overall plurality of measurements of the plurality of linear frequency modulated signals, wherein each measurement, among the overall plurality of measurements, is associated with a linear frequency modulated signal, among the plurality of linear frequency modulated signals. The method includes obtaining a fused measurement by grouping a given plurality of measurements, among the overall plurality of measurements, where each given measurement, among the given plurality of measurements, is associated with a particular linear frequency modulated signal, among the plurality of linear frequency modulated signals, where each particular linear frequency modulated signal has, in common, a spatial parameter. An apparatus is also provided to carry out this method. A computer-readable medium is provided storing instructions to cause a computer to carry out this method. A computer program is provided to cause a computer to carry out this method.

According to an aspect of the present disclosure, there is provided a method. The method includes receiving, over a plurality of frequency bands or a plurality of measurement time windows, a plurality of non-contiguous linear frequency modulated signals and applying, a particular linear frequency modulated signal, among the plurality of non-contiguous linear frequency modulated signals, a de-chirping process, the de-chirping process using a particular reverse chirp signal, wherein the particular reverse chirp signal has a chirp rate that matches a chirp rate of the particular linear frequency modulated signal. An apparatus is also provided to carry out this method. A computer-readable medium is provided storing instructions to cause a computer to carry out this method. A computer program is provided to cause a computer to carry out this method.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates a representation of sensing signals transmitted over a plurality of relatively small bandwidth parts and a plurality of time-limited measurement windows, in accordance with aspects of the present application;

FIG. 7 illustrates three sensing signals configured over respective relatively small bandwidth parts and over respective measurements windows, in accordance with aspects of the present application;

FIG. 8 illustrates an example of chirp hopping;

FIG. 9 schematically illustrates a structure for a receiver at a sensing RX node, in accordance with aspects of the present application; and

FIG. 10 illustrates, in a signal flow diagram, communication between a sensing management function, a sensing TX node and a sensing RX node, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

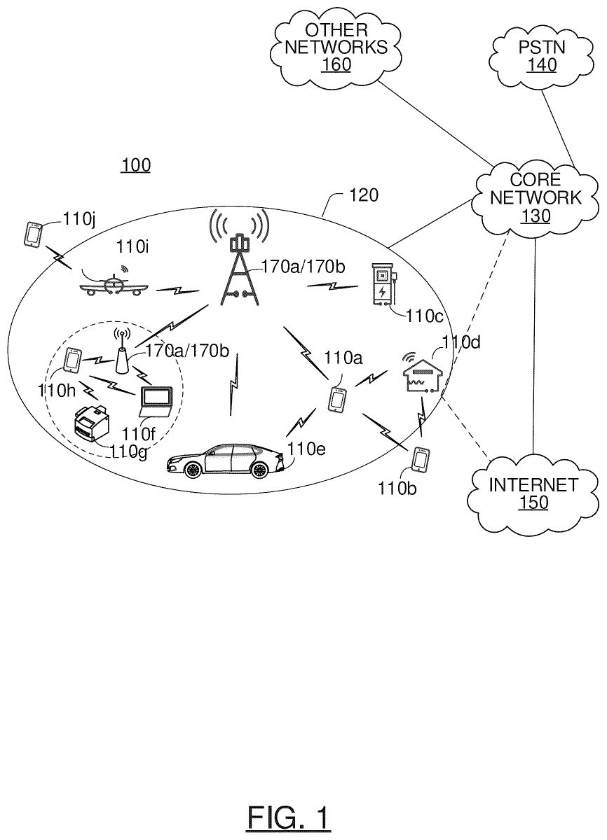

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

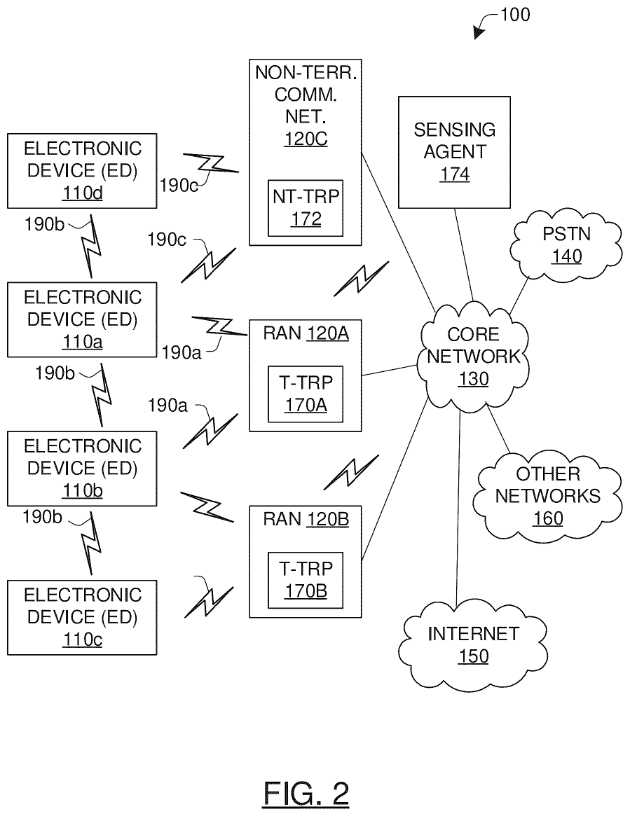

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

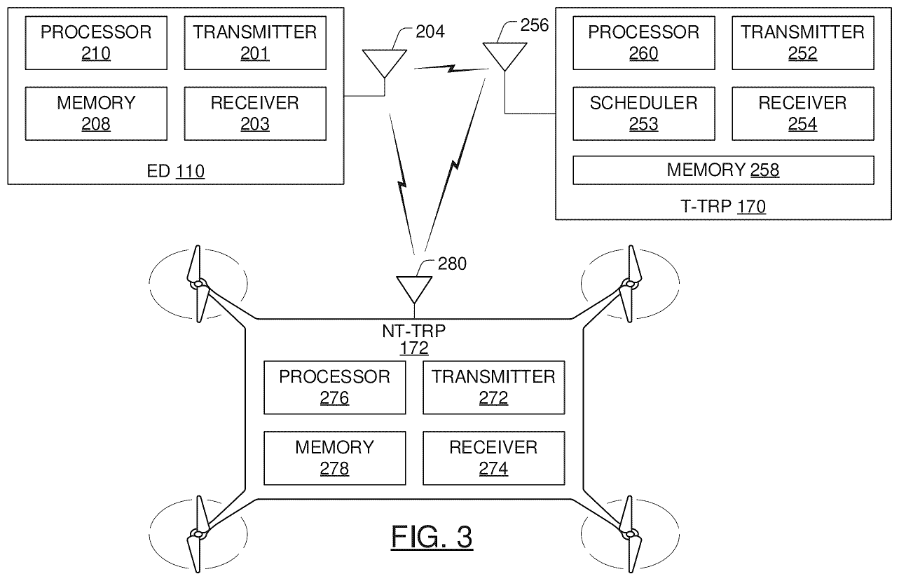

FIG. 3 illustrates another example of an ED 110 and a base station 170a, 170b and/or 170c. The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, wearable devices (such as a watch, a pair of glasses, head mounted equipment, etc.), an industrial device, or an apparatus in (e.g., communication module, modem, or chip) or comprising the foregoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated to avoid congestion in the drawing. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to, or receiving information from, a user, and/or for network interface communications. Suitable structures include, for example, a speaker, a microphone, a keypad, a keyboard, a display or a touch screen, etc.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g., a communication module, a modem or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated to avoid congestion in the drawing. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Signaling may be transmitted in a physical layer control channel, e.g., a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g., in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

The scheduler 253 may be coupled to the processor 260. The scheduler 253 may be included within, or operated separately from, the T-TRP 170. The scheduler 253 may schedule uplink, downlink, sidelink and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a programmed FPGA, a hardware accelerator (e.g., a GPU or an AI accelerator) or an ASIC.

Notably, the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a hardware accelerator (e.g., a GPU or an AI accelerator) or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

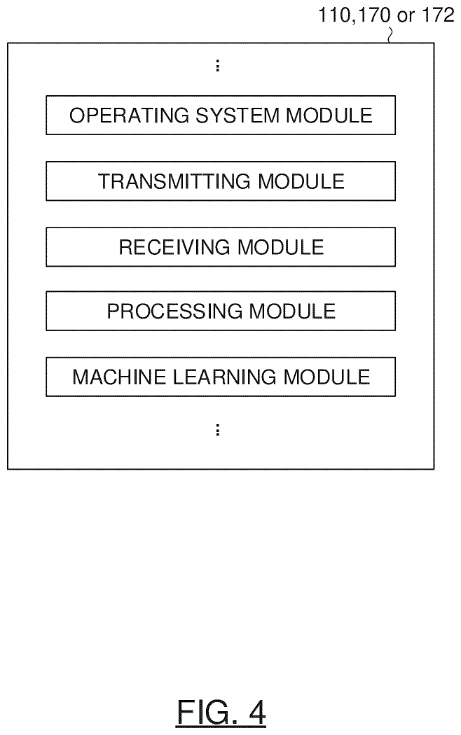

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or by a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit include a programmed FPGA, a CPU, a GPU or an ASIC. For instance, one or more of the units or modules may be logical such as a logical function performed by a circuit, by a portion of an integrated circuit, or by software instructions executed by a processor. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may expect relatively fast initial access, in which case the frame length may be set to 5 ms for autonomous vehicle applications. As another example, smart meters on houses may not expect fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers. Notably, it should be understood that the terms “bandwidth part (BWP),” “frequency sub-bands,” “frequency bands” and “frequency chunks” refer to the same concept, that is, a contiguous interval/resource in the frequency domain.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

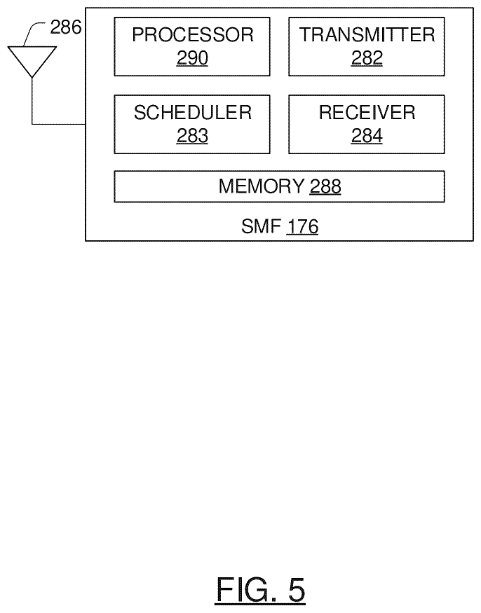

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

Next generation wireless communication systems may be referred to as “beyond 5G” communication systems or referred to as sixth generation (6G) communication systems. In the next generation wireless communication systems, nodes, including network nodes and user equipment (UE), are envisioned to be able to perform communication and sensing functionalities simultaneously, while maintaining relatively high spectral efficiency. Moreover, most of the envisioned applications and use-cases of next generation wireless communication systems benefit from complying with stringent sensing accuracy specifications. For instance, so-called digital twin applications may specify 1 cm and 10 cm lateral and longitudinal accuracy and/or resolution, respectively. Meeting these specifications may be shown to involve allocating relatively huge bandwidth at each node for accommodating both functionalities, while achieving a desired communication rate and sensing accuracy. For instance, theoretically, a positioning accuracy and/or resolution of 10 cm may involve using sensing signals with at least 3 GHz bandwidth for time/delay-measurement based positioning methods. However, only a few nodes in the network are expected to have such relatively good sensing capability in terms of transmitting/receiving and processing such ultra-wide bandwidth sensing signals. Thus, it may be considered that there is likely to exist a bottleneck in obtaining relatively high-resolution sensing information in next generation wireless communication systems.

In contrast, low power consumption and low operational complexity may be considered to be main enablers for many applications of next generation wireless communication systems. For instance, 6G IoT networks and applications are expected to employ a relatively large number of low-end sensors and serve many low-capability UEs across their networks. These low-end sensors and low-capability UEs are expected to have relatively tight power limitations and relatively tight computational complexity limitations. These limitations may be shown to limit the ability of the network to enable relatively high-resolution, network-wide sensing services. These limitations may also be shown to hinder the adoption of emerging applications that utilize sensing associated with low-power and low-complexity.

It follows that methods for providing reliable, relatively high-resolution sensing information services for electronic devices with limited energy and low bandwidth and/or dynamic range are desired.

Aspects of the present application relate to configuring a target UE to be a sensing RX node. That is, providing the target UE with a configuration that allows the target UE to collect sensing information, where generation of the configuration takes into consideration low power and low computational complexity. The configuration may be based on receiving a chirp-based sensing waveform, a plurality of measurements over a plurality of bandwidth parts or, equivalently, over a plurality of time slots, due to time-frequency relation of chirp-based signals. This may enable fusing these measurements in the frequency domain and/or the time domain, thereby producing fused measurements. The fused measurements may be shown to increase an aggregated bandwidth and, thereby, the fused measurements may be shown to increase sensing resolution. Through appropriate configuration of the chirp-based sensing signal, the parameters reported by a sensing RX node, to a sensing TX node, may allow the sensing TX node to obtain a range and/or a Doppler frequency for the sensing RX node. Notably, the measurement fusion process may be carried out at the sensing RX node or at the sensing TX node. Conveniently, those aspects of the present application that relate to sensing procedures may be shown to be associated with power consumption and computational complexity that is reduced relative to power consumption and computational complexity associated with known sensing procedures.

According to some aspects of the present disclosure, an increase of the aggregated bandwidth (or sensing periods-time slots) due to the fusing of measurements may be shown to lead to an enhancement of the accuracy and/or resolution of sensing procedures. The enhanced accuracy and/or resolution may be shown to, in turn, facilitate other communication procedures. The enhancement of the accuracy of the sensing procedures may be shown to be due to efficient joint design and joint configuration of the sensing procedures over a plurality of bandwidth parts and/or a plurality of sensing periods, thereby enabling proper sensing measurements fusion. The enhancement of accuracy and/or resolution in sensing procedures may further enable efficient management and optimization of network resources based on range or Doppler frequency information.

Many existing approaches for bandwidth aggregation are limited to communication alone (i.e., without a sensing component), wherein a main objective is to increase an aggregated “communication” data rate for a certain UE, rather than to increase sensing resolution or increase accuracy. Furthermore, existing approaches may be considered to be limited to use of a plurality of bandwidth parts to send a plurality of distinct data streams. These data streams may not need to be fused or processed jointly to be used. Indeed, in the existing approaches, each data stream may be shown to be treated and processed independently. A single data stream transmitted over a single bandwidth part may be shown to represent, by itself, information that is useful to the receiver. In other words, in these approaches, it may be shown that there is no effort put into joint design or optimization before transmitting multiple data streams over multiple bandwidth parts. In addition, existing approaches for bandwidth aggregation may be seen to be limited to the utilization of cyclic prefix orthogonal frequency division multiplexing (CP-OFDM) waveforms.

Existing approaches for sensing systems may be shown to utilize linear frequency mode modulation or linear frequency modulated (LFM) waveforms (also widely known as chirp modulation waveforms) to enable low complexity RF-dominant signal detection and processing. To achieve high-resolution sensing information, existing approaches utilize ultra-wideband chirp-based signals that involve de-chirping the sensing signals with an ultra-wideband reverse chip signal at a receiver. The use of an ultra-wideband reverse chip signal might not be practically feasible for some UEs. As will be appreciated, a reverse chirp signal is a chirp signal with a chirp rate that has the same absolute value as the chirp rate of the original chirp signal and a sign that is the opposite of the sign of the chirp rate of the original chirp signal.

An advantage of the sensing procedures of aspects of the present application is the suitability of the employment of the aspects by low-end UEs. Aspects of the present application may be shown to operate effectively over multiple contiguous or non-contiguous time slots and bandwidth parts resources.

A further advantage of sensing procedures representative of aspects of the present application is an enablement low-complexity sensing detection and estimation. Aspects of the present application may be shown to operate effectively by employing simple RF-dominant operations and processing.

An even further advantage of sensing procedures representative of aspects of the present application is operation in low power modes. Aspects of the present application may be shown to operate effectively by employing low-sampling-rate baseband operation.

A still further advantage of sensing procedures representative of aspects of the present application is a relatively low signaling and feedback overhead. Aspects of the present application relate to feeding back, to the sensing TX node, a received signal or an indication of the received signal by embedding the received signal or an indication of the received signal in a transmission from the sensing RX node to the sensing TX node.

According to an aspect of the present disclosure, there is provided a method of obtaining relatively high-resolution sensing information, e.g., range and Doppler frequency shift, to associate with a sensing RX node. The method may include transmitting, to the sensing RX node, configuration information for a plurality of chirp-based sensing signals. The configuration may include, for each chirp-based sensing signal, one or more of: an indication of a bandwidth part; an indication of a measurement time window; an indication of an initial frequency; and an indication of a chirp rate. The method may include transmitting, to the sensing RX node, chirp-based sensing signals over the plurality of bandwidth parts and the plurality of measurement time windows. The method may include receiving, from the sensing RX node, an indication that the fusion of the measurements taken over the plurality of bandwidth parts and the plurality of measurement time windows, has been successful. The method may include receiving, from the sensing RX node, feedback. The feedback may include relatively high-resolution sensing parameters, estimated, at the sensing RX node, based on successful measurements fusion and interpolation processes carried out at the sensing RX node.

According to an aspect of the present disclosure, there is provided a method of facilitating the obtaining of relatively high-resolution sensing information for associating with a sensing RX node. The method includes receiving, at a sensing TX node from the sensing RX node, an indication of a capability of the sensing RX node. The capability indication may include a plurality of parameters. The method may include receiving, at the sensing TX node from the sensing RX node, an indication about the status of measurement fusion and interpolation processes at the sensing RX node. The method may include receiving, at the sensing TX node from the sensing RX node, relatively high-resolution sensing parameters, estimated, at the sensing RX node based on processing measurements of received sensing signals. Alternatively, the method may include receiving, at the sensing TX node from the sensing RX node, the received sensing signals or indications of the received sensing signals.

According to an aspect of the present disclosure, there is provided a method of facilitating the obtaining of a position for a sensing RX node. The method includes receiving, at the sensing RX node, configuration information for a node-specific chirp-based sensing signal. The method may include receiving, at the sensing RX node, a chirp-based sensing signal, over a plurality of bandwidth parts and a plurality of measurement time windows. Indeed, the node-specific nature of the chirp-based sensing signal may be based on tailoring, at the sensing TX node, the chirp-based sensing signal according to capabilities of the sensing RX node.

According to an aspect of the present disclosure, there is provided a method of grouping sensing measurements. The sensing measurements to be grouped may be measurements of sensing signals received, over a plurality of bandwidth parts and a plurality of measurement time windows, by a particular sensing RX node. Furthermore, the sensing signals associated with the sensing measurements to be grouped may have, in common, spatial parameters, e.g., the sensing signals may have been transmitted over the same beamforming beam and/or the sensing signals may have been transmitted from the same antenna port.

According to an aspect of the present disclosure, there is provided a method of measurements fusion and interpolation, which may be carried out at a sensing RX node. The method comprises de-chirping the received signals, wherein the received signals are received at the sensing RX node over a plurality of bandwidth parts or a plurality of measurement time windows, wherein the de-chirping using a reverse chirp signal. The method may comprise being preconfigured based on configuration, received from the sensing TX node. The configuration may include: low resolution sampling procedures to the output of the de-chirping process, phase offset compensation, interpolation process for the non-contiguous received signals either in time or frequency domain, and a measurement fusion process which is based on utilizing hierarchical multi-resolution time/frequency interpolation dictionaries and successive interference canceling procedures, wherein, at each iteration, one parameter is estimated and its effect or contribution to the interpolated received signal is successively removed.

Existing sensing approaches, including, e.g., known sensing approaches that use radar, have introduced the use of linear, frequency-mode modulation or linear frequency modulated (LFM) waveforms, widely known as “chirp modulation” waveforms or “chirp-based” waveforms. LFM waveforms may be shown to enable low-complexity, RF-dominant signal detection and processing. It may be shown that chirp-based waveforms are associated with relatively simple and practical receivers. Receivers for chirp-based waveforms may be based on a simple de-chirping mixer and a simple beat frequency detector. In receivers for chirp-based waveforms, it is typical to multiply a received RF signal by a reverse chirp signal, wherein the reverse chirp signal has the same frequency modulation rate as the received RF signal.

One advantage of a receiver based on a simple de-chirping mixer and a simple beat frequency detector is that a sampling rate used to estimate a beat frequency may be shown to be much smaller than the Nyquist rate of the transmitted signal. In particular, consider the simple case of a transmitted sensing signal, s_{Tx}(t), where s_{Tx}(t)=e^{jπαt}^{²}. The term α is representative of a chirp rate, where

$$α = \frac{B}{T} ,$$

where B represents bandwidth and the term T represents period. The received signal, s_{Rx}(t), at a sensing RX node, assuming that the channel has one path that has a unit channel gain, may be represented as s_{Rx}(t)=s_{Tx}(t−τ), where the term, τ, is representative of a time of flight of the sensing signal. The receiver may multiply the received signal, s_{Rx}(t), by a conjugate,

$${s}_{T x}^{*} ( t ) ,$$

of the transmitted sensing signal, to produce a product signal, y(t). The conjugate,

$${s}_{T x}^{*} ( t ) ,$$

of the transmitted sensing signal may be called a de-chirping signal. The product signal, y (t), may be represented by an expression,

$$y ( t ) = {s}_{R x}^{*} ( t ) \cdot {s}_{R x} ( t ) = {e}^{j ϕ} {e}^{- j 2 π α τ t} ,$$

where φ is a term representative of a phase-shift and φ=πατ².

It may be shown that determining a value for the delay, τ, is equivalent to detecting the parameters of an exponential function, e^{-j2πατt}. Detecting the parameters of that exponential function may, in turn, be shown to correspond to detecting a frequency, ατ, of a received sinusoid signal. It may be shown that detecting that frequency may be efficiently accomplished through the use of a Fast Fourier transform (FFT) operation and low resolution sampling. Although this type of receiver has low complexity (in terms of utilizing a relatively low sampling rate), this type of receiver also relies upon a condition that the bandwidth of the de-chirping signal, s_{Tx}^{*}(t), matches the bandwidth of the transmitted signal. The bandwidth of the transmitted signal is typically relatively large. The relatively large bandwidth may be shown to hinder wide utilization of wideband chirp-based sensing signals in many sensing applications.

Some aspects of the present application relate to sensing methods that alleviate the problems associated with the use of ultra-wide bandwidth sensing signals. These methods may be shown to alleviate the problems by utilizing multiple low-bandwidth, chirp-based sensing signals and low complexity receiving circuitries, while providing relatively high-resolution sensing information for a sensing RX node.

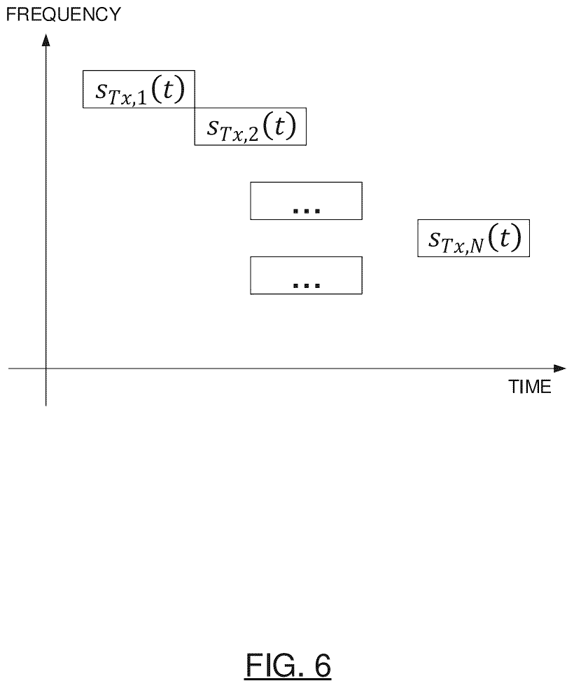

Some aspects of the present application relate to allowing cooperation between a sensing TX node and a sensing RX node in such a way as to allow the sensing TX node to transmit sensing signals over a plurality of relatively small bandwidth parts and a plurality of time-limited measurement windows (as illustrated in FIG. 6).

FIG. 6 illustrates representations of a plurality of sensing signals, s_{Tx,1}(t), s_{Tx,2}(t), . . . , s_{Tx,N}(t), that may be transmitted over a plurality of relatively small bandwidth parts and a plurality of time-limited measurement windows. The plurality of sensing signals may be understood to have been created at the sensing TX node in such a way that facilitates interpolation of received versions of the plurality of sensing signals at the sensing RX node. Accordingly, it may be shown that a fusion of measurements of the received versions facilitated.

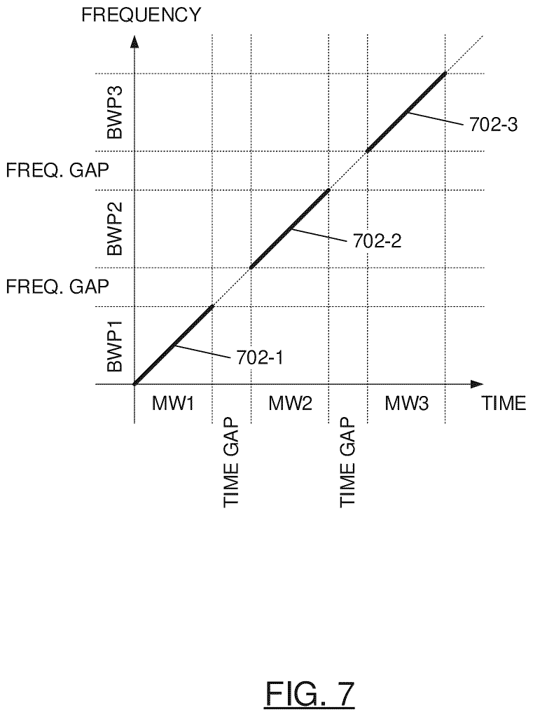

In FIG. 7, three sensing signals 702-1, 702-2, 702-3 (collectively or individually referenced as 702) are configured over respective relatively small bandwidth parts (BWP1, BWP2, BWP3) and over respective measurements windows (MW1, MW2, MW3). Additionally, it may be shown that the configurations of the sensing signals 702 may be tuned, at the sensing TX node, to allow for measurement fusion at the sensing RX node. In particular, use of the same chirp rate, α, for all three sensing signals 702, as illustrated in FIG. 7, allows for the sensing TX node to set time gaps and frequency gaps between the sensing signals in such a way that when the sensing RX node properly fuses measurements of received versions of the three sensing signals 702, the sensing RX node is enabled to achieve an appropriately high sensing resolution.

Notably, the more the sensing signals 702 are separated in time and frequency, i.e., the larger the time domain gaps between the sensing signals and the larger the frequency domain gaps between the sensing signals, the higher the sensing resolution the sensing RX node can achieve after proper measurement fusion. Further notably, however, the higher sensing resolution is associated with higher difficulty for measurement fusion and with higher difficulty for interpolation processes.

Aspects of the present application relate to the sensing RX node transmitting a sensing capability report to the sensing TX node. Upon receiving, from the sensing RX node, the sensing capability report, the sensing TX node may tailor a plurality of chirp-based sensing signals in a manner that takes into account the sensing RX node capabilities, as indicated in the sensing capability report. The sensing capability report may, for example, indicate those capabilities of the sensing RX node that are related to processing chirp-based sensing signals. Such capabilities may include a maximum supported measurement bandwidth, which is related to a maximum bandwidth of the sensing RX node de-chirping circuitry. Such capabilities may include minimum supported measurement gap, which is related to the minimum time domain gap between two consecutive measurement windows, supported measurement window durations and maximum supported sampling rate per measurement window. Capability reports may indicate capabilities of the sensing RX node that are related to performing measurement fusion processes. Such capabilities may include, for example, a capability to estimate phase offset between measurement windows and/or bandwidth parts and a capability to estimate a maximum gap between the measurement windows.

The identification, at the sensing TX node, of a plurality of chirp-based sensing signals appropriate to the capabilities of the sensing RX node may include identifying a bandwidth of a measurement window, a duration of time-domain symbols, an initial frequency, a chirp rate and a number of the measurement windows.

Aspects of the present application relate to defining fusion groups in some scenarios. A fusion group is a group of measurements that are potentially fusible, e.g., a group of measurements that may have high chances of allowing for an improvement in time resolution through aggregation over different bandwidth parts. Accordingly, a fusion group may also be called a “measurement group.” For example, the sensing TX node may carry out so-called “chirp hopping” in a slope domain. That is, the sensing TX node may change the sign and/or the value of the chirp rate, α.

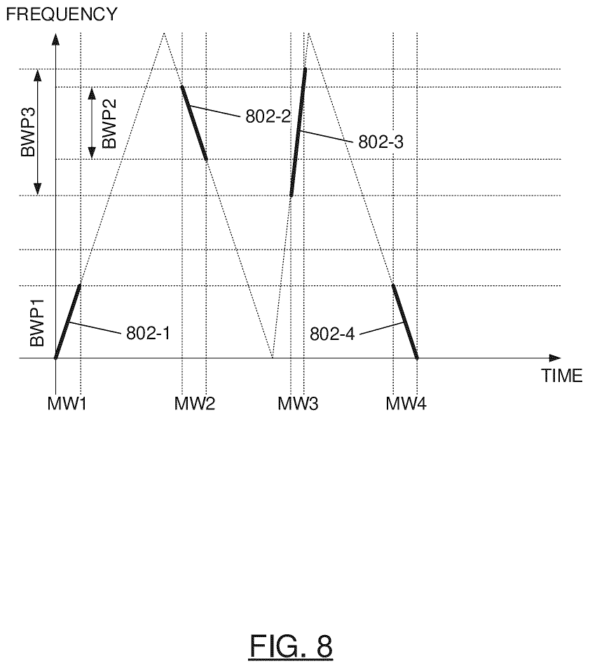

FIG. 8 illustrates an example of chirp hopping. FIG. 8 illustrates a chirp-based sensing signal. The chirp-based sensing signal illustrated in FIG. 8 is created by a sensing TX node multiplexing a plurality of chirp-based sensing signal pieces: a first chirp-based sensing signal piece 802-1; a second chirp-based sensing signal piece 802-2; a third chirp-based sensing signal piece 802-3; and a fourth chirp-based sensing signal piece 802-4 (individually or collectively 802). Each chirp-based sensing signal piece 802 is associated with a measurement window, a bandwidth part and a slope. The first chirp-based sensing signal piece 802-1 is associated with a first measurement window MW1 and a first bandwidth part BP1. The second chirp-based sensing signal piece 802-2 is associated with a second measurement window MW2 and a second bandwidth part BP2. The third chirp-based sensing signal piece 802-3 is associated with a third measurement window MW3 and a third bandwidth part BP3. The fourth chirp-based sensing signal piece 802-4 is associated with a fourth measurement window MW4 and the first bandwidth part BP1.

As mentioned hereinbefore, aspects of the present application relate to use of measurement fusion at a sensing RX node. It may be shown that measurement fusion, in the case of chirp-based sensing signals, may be considered to involve collecting multiple pieces of the same exponential functions. Accordingly, the sensing TX node may need to specify, to the sensing RX node, which pieces of a transmitted chirp signal are good candidates for having their measurements fused together after the de-chirping process. For example, in FIG. 8, the first chirp-based sensing signal piece 802-1 and the third chirp-based sensing signal piece 802-3 may be poor candidates for having their measurements fused together, since the first chirp-based sensing signal piece 802-1 and the third chirp-based sensing signal piece 802-3 have different slopes and, accordingly, may be expected to correspond to different exponential functions. On the other hand, the second chirp-based sensing signal piece 802-2 and the fourth chirp-based sensing signal piece 802-4 may be good candidates for having their measurements fused together, since the second chirp-based sensing signal piece 802-2 and the fourth chirp-based sensing signal piece 802-4 have the same slope sign and may be expected to correspond to the same exponential function.

To facilitate fusing measurements of the first chirp-based sensing signal piece 802-1 and the third chirp-based sensing signal piece 802-3, an extra indication may be sent from the sensing TX node to the sensing RX node. This extra indication may comprise a sampling frequency adjustment value. Notably, a ratio between a sampling frequency for the third chirp-based sensing signal piece 802-3 and a sampling frequency for the first chirp-based sensing signal piece 802-1 may be shown to correspond to a ratio between a chirp slope for the third chirp-based sensing signal piece 802-3 and a chirp slope for the first chirp-based sensing signal piece 802-1, if their corresponding measurements are suitable to be fused together. Accordingly, before obtaining a fused measurement of the first chirp-based sensing signal piece 802-1 and the third chirp-based sensing signal piece 802-3, the sampling frequency adjustment value may be used to adjust a chirp rate of the first chirp-based sensing signal piece 802-1. Conveniently, after the adjustment, a measurement of the adjusted first chirp-based sensing signal piece 802-1 may be fused with a measurement of the third chirp-based sensing signal piece 802-3.

Establishing that a plurality of chirp-based sensing signal pieces 802 are good candidates for having their measurements fused together may be referred to as establishing a fusion group. Establishing a fusion group may be understood to involve associating chirp-based sensing signal pieces 802 into a fusion group. Establishing a fusion group may be shown to be beneficial when the chirp-based sensing signal pieces are transmitted, from the sensing TX node, over different beamforming beams or, equivalently, over different spatial directions/layers. In this case, the chirp-based sensing signal pieces 802 that correspond to the same beamforming beam/spatial layer may be grouped in the same fusion group since it may be shown that their corresponding measurements are highly fusible.

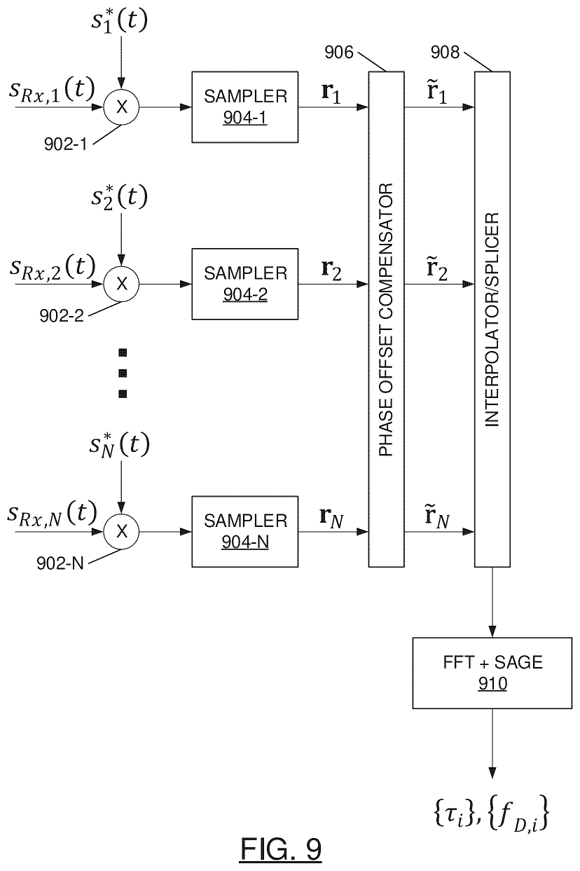

FIG. 9 schematically illustrates a structure for a receiver 900 at the sensing RX node. At the sensing RX node, a fusion group of chirp-based sensing signal pieces 802 may be received over a plurality of bandwidth parts and in a plurality of measurement windows. Each received chirp-based sensing signal piece, s_{Rx,1}(t), s_{Rx,2}(t), . . . , s_{Rx,N}(t), may be de-chirped using a corresponding de-chirping mixer 902-1, 902-2, . . . , 902-N(individually or collectively 902). It is known that a de-chirping mixer 902 may be defined by a set of coefficients. The coefficients employed by the de-chirping mixer 902-i may be selected to correspond to a complex conjugate, sᵢ^{*}(t), of a transmitted chirp-based sensing signal piece, s_{Tx,i}(t).

Subsequent to the de-chirping process, each de-chirped signal piece may be sampled using a low-resolution, time-domain sampler 904-1, 904-2, . . . , 904-N(individually or collectively 904). The sampling rate used by each low-resolution, time-domain sampler 904 may be selected to achieve a particular accuracy for a plurality of parameters that are to be estimated. Output of the low-resolution, time-domain sampler 904 may be a sampled received vector, rᵢ. Each sampled received vector, rᵢ, corresponding to an i^{th} de-chirped signal after the sampling process, carried out at the low-resolution, time-domain sampler 904, may be passed through a phase offset compensator 906. The phase offset compensator 906 may be understood to carry out at phase offset compensation process that prepares the sampled received vectors, rᵢ, for i=1, . . . , N, to be interpolated and fused coherently. Output from the phase offset compensator 906 may be referenced as phase-compensated, received-sampled vectors, \tilde{r}ᵢ, for i=1, . . . , N. Notably, the phase-compensated received-sampled vectors, \tilde{r}ᵢ, may be shown to have spectrum allocations that correspond to their transmission over different bandwidth parts and over different frequency carriers.

After the phase offset compensator 906, the phase-compensated received-sampled vectors, ĩᵢ, may be received by a interpolator/splicer 908. At the interpolator/splicer 908, the phase-compensated received-sampled vectors, \tilde{r}ᵢ, may be fused together, either in the time domain or in the frequency domain. The proper fusion domain (time or frequency) may depend on the intended application. Additionally, or alternatively, the proper fusion domain (time or frequency) may depend on the type of the waveform utilized in sensing. Additionally, or alternatively, the proper fusion domain (time or frequency) may depend on the type of the spectrum allocation available for the sensing signals. The types of spectrum allocation available for the sensing signals may be considered to be either contiguous-type spectrum allocation or non-contiguous-type spectrum allocation.

Notably, when the chirp-based sensing signal pieces 802 are allocated contiguously in the frequency domain, the complexity of the measurements fusion process is reduced compared to when the chirp-based sensing signal pieces 802 are allocated non-contiguously in the frequency domain. However, the reduced complexity comes at a price of lower time-resolution gain. Particularly, the time-resolution gain due to fusing measurements that have contiguous spectrum allocation may be considerably lower than the time-resolution gain corresponding to fusing measurement that have non-contiguous spectrum allocation. Notably, a time-resolution gain that corresponds to the fusing of measurements that have non-contiguous spectrum allocation, may be shown to scale proportionally with a sum of the bandwidths of the fused measurements and the inter-band carriers spacing. However, the time-resolution gain that corresponds to the fusing of measurements that have contiguous spectrum allocation may be shown to scale only with sum of the bandwidths of the fused measurements.

Notably, one reason for the increased complexity of fusing measurements having non-contiguous spectrum allocation is an interpolation process that may be applied to these measurements before fusing the measurements. One beneficial aspect of chirp-based sensing signals is that chirp-based sensing signals may be shown to facilitate interpolation between to-be-fused measurements in the time domain, due to the special structure of the chirp-based sensing signals. One candidate method for interpolation involves using multi-resolution hierarchical dictionaries that exploit the special structure of chirp-based sensing signals and the sparsity of the sensing parameters that are to be estimated. This candidate method may be shown to efficiently approximate an exponential function of the sensing parameters.

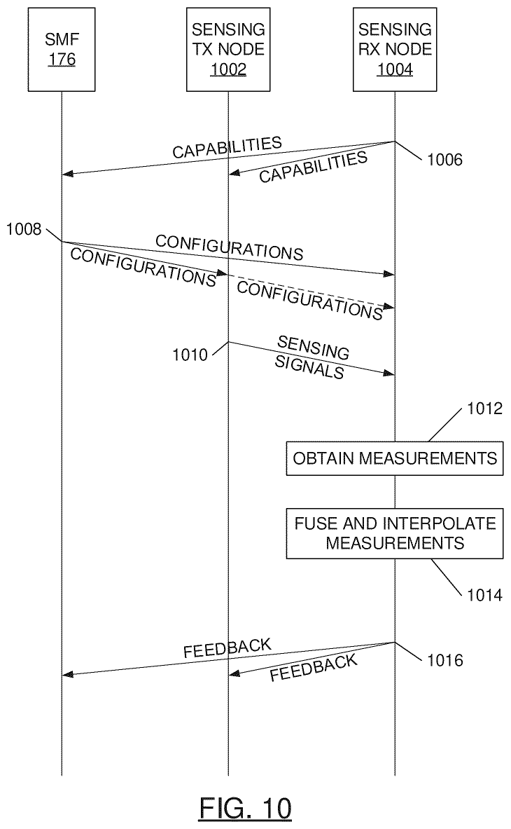

FIG. 10 illustrates, in a signal flow diagram, communication between the SMF 176, a sensing TX node 1002 and a sensing RX node 1004. The sensing RX node 1004 may, in some cases, represent a low power UE that is seeking high resolution sensing information. Initially, the sensing RX node 1004 may provide (step 1006) the SMF 176 and/or the sensing TX node 1002 with a capability report including indications of fusion capabilities of the sensing RX node 1004. Such fusion capabilities may include a capability of the sensing RX node 1004 for receiving multiple bandwidth parts, handling multiple measurements windows, a dynamic range for the sensing RX node 1004 and a maximum sampling rate. These fusion capabilities may be provided (step 1006) using control signaling, e.g., RRC signaling or as part of a media access control-control element (a “MAC-CE”) signaling.

Subsequent to receiving the capability report, the SMF 176 may provide (step 1008), to the sensing RX node 1004 and to the sensing TX node 1004, configurations. These configurations may be related to spectrum allocation and time allocation for chirp-based sensing signals along with parameters for the chirp-based sensing signals. The parameters may be configured, by the SMF 176, based on the capabilities of the sensing RX node 1004, a specified accuracy of the parameters to be sensed and available time-spectrum resources of the network.

In some scenarios, there may be no explicit signaling, to the sensing RX node, of the spectrum allocation and time allocation for the measurement windows and/or the bandwidth parts. In those no-explicit-signaling scenarios, there may be a set of potential measurement windows and/or a set of potential bandwidth parts defined as well as a mapping function between an identifier of the sensing RX node 1004 and a configured set of measurement windows and/or bandwidth parts among the set of potential measurement windows and/or bandwidth parts. In such no-explicit-signaling scenarios, higher-layer signaling (e.g., RRC or MAC-CE) may be used for indicating the set of potential measurement windows and/or bandwidth parts as well as the parameters of a mapping function.

Subsequent to receiving, at the sensing TX node 1002, the sensing signal configuration, the sensing TX node 1002 may transmit (step 1010) chirp-based sensing signals over a plurality of bandwidth parts or, equivalently, over a plurality of measurement windows (time slots). Depending on the scenario, the chirp-based sensing signals transmitted (step 1010), by the sensing TX node 1002, may be implemented as downlink chirp-based sensing signals, uplink chirp-based sensing signals or sidelink chirp-based sensing signals.

Upon receiving, at the sensing RX node 1004, the chirp-based sensing signals, the sensing RX node 1004 may obtain (step 1012) measurements. The sensing RX node 1004 may then commence a process (step 1014) that includes interpolation of the measurements and fusion of the measurements. The process (step 1014) may produce, as output, estimated values for the parameters to be sensed. The sensing RX node 1004 may then transmit (step 1016) feedback to the sensing TX node 1002 and/or the SMF 176. The feedback may include the estimated values for the parameters.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. An apparatus comprising:
at least one processor; and
a memory coupled to the at least one processor, the memory storing instructions that, when executed by the at least one processor, cause the apparatus to perform operations including:
communicating configuration information, wherein the configuration information includes, for each linear frequency modulated signal among a plurality of linear frequency modulated signals, at least one of an indication of a corresponding frequency band or an indication of a corresponding measurement time window; and
transmitting the plurality of linear frequency modulated signals to a sensing receiver node.

2. The apparatus of claim 1, wherein the communicating the configuration information comprises transmitting the configuration information to the sensing receiver node.

3. The apparatus of claim 1, wherein the communicating the configuration information comprises receiving the configuration information from a network node.

4. The apparatus of claim 1, wherein the operations further include:
receiving feedback from the sensing receiver node, the feedback including a value for a sensing parameter estimated at the sensing receiver node, based on a fusion of measurements, made at the sensing receiver node, of the plurality of linear frequency modulated signals; and
receiving, from the sensing receiver node, an indication that the fusion of measurements has been successful.

5. The apparatus of claim 4, wherein the operations further include:
processing the sensing parameter to obtain at least one of a range or a Doppler frequency shift.

6. The apparatus of claim 1, wherein the configuration information further comprises an indication of a corresponding initial frequency for each linear frequency modulated signal among the plurality of linear frequency modulated signals.

7. The apparatus of claim 1, wherein the configuration information further comprises an indication of a corresponding rate for each linear frequency modulated signal among the plurality of linear frequency modulated signals.

8. The apparatus of claim 1, wherein the operations further include:
receiving, from the sensing receiver node, an indication of a capability associated with the sensing receiver node.

9. An apparatus comprising:
at least one processor; and
a memory coupled to the at least one processor, the memory storing instructions that, when executed by the at least one processor, cause the apparatus to perform operations including:
receiving, over a plurality of frequency bands and a plurality of measurement time windows, a plurality of linear frequency modulated signals;
obtaining an overall plurality of measurements of the plurality of linear frequency modulated signals, wherein each measurement, among the overall plurality of measurements, is associated with a corresponding linear frequency modulated signal, among the plurality of linear frequency modulated signals; and
obtaining a fused measurement by grouping a plurality of measurements, among the overall plurality of measurements, wherein each measurement, among the plurality of measurements, is associated with the corresponding linear frequency modulated signal, among the plurality of linear frequency modulated signals, and wherein the corresponding linear frequency modulated signal has, in common, a spatial parameter.

10. The apparatus of claim 9, wherein the operations further include:
receiving configuration information, wherein the configuration information includes, for each linear frequency modulated signal among the plurality of linear frequency modulated signals, at least one of an indication of a corresponding frequency band or an indication of a corresponding measurement time window.

11. The apparatus of claim 9, wherein the operations further include:
transmitting feedback including a value for a sensing parameter estimated based on a fusion of the plurality of measurements, of the plurality of linear frequency modulated signals.

12. The apparatus of claim 9, wherein the receiving the plurality of linear frequency modulated signals comprises:
receiving the plurality of linear frequency modulated signals over a beamforming beam.

13. The apparatus of claim 9, wherein the receiving the plurality of linear frequency modulated signals comprises:
receiving the plurality of linear frequency modulated signals over a spatial layer.

14. The apparatus of claim 9, wherein the receiving the plurality of linear frequency modulated signals comprises:
receiving the plurality of linear frequency modulated signals transmitted from an antenna port.

15. The apparatus of claim 9, wherein the operations further include:
receiving a sampling frequency adjustment value.

16. An apparatus comprising:
at least one processor; and
a memory coupled to the at least one processor, the memory storing instructions that, when executed by the at least one processor, cause the apparatus to perform operations including:
receiving, over a plurality of frequency bands or a plurality of measurement time windows, a plurality of non-contiguous linear frequency modulated signals; and
applying, to a linear frequency modulated signal, among the plurality of non-contiguous linear frequency modulated signals, a de-chirping process, the de-chirping process using a reverse chirp signal, wherein the reverse chirp signal has a chirp rate with an inverse that matches a chirp rate of the linear frequency modulated signal.

17. The apparatus of claim 16, wherein the operations further include:
receiving a configuration.

18. The apparatus of claim 17, wherein the configuration indicates parameters for a low-resolution sampling procedure to be applied to an output of the de-chirping process.

19. The apparatus of claim 17, wherein the configuration indicates parameters for a phase offset compensation process.

20. The apparatus of claim 17, wherein the configuration indicates parameters for a measurement fusion process, wherein the measurement fusion process is based on utilizing hierarchical, multi-resolution time or frequency interpolation dictionaries and successive interference canceling procedures including a plurality of iterations, wherein, at each iteration of the plurality of iterations, the operations further comprise:
estimating a parameter; and
removing, from the plurality of non-contiguous linear frequency modulated signals, an effect of the parameter.
